(19) United States
(12) Patent Application Publication
(10) Pub. No.: US 2026/0110348 A1
(43) Pub. Date: Apr. 23, 2026

(54) VIBROACOUSTIC STRUCTURE SYSTEM

(71) Applicant: Tusas- Turk Havacilik Ve Uzay Sanayii Anonim Sirketi, Kahramankazan, Ankara (TR)

(72) Inventors: Mustafa BAL, Kahramankazan, Ankara (TR); Huseyin Cemal TASTAN, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/117,050

(22) PCT Filed: Sep. 26, 2023
(86) PCT No.: PCT/TR2023/051025

§ 371 Date: Mar. 30, 2025

(30) Foreign Application Priority Data
Sep. 30, 2022 (TR) 2022/015020

(51) Int. Cl. F16F 15/02

(52) U.S. Cl. CPC F16F 15/02; F16F 2224/0225; F16F 2228/04

(57) ABSTRACT

The present invention relates to a body (2) in an air vehicle, which is subjected to vibration; a plurality of unit cells (3) located on the body (2); a plate (4) which is located on the body (2) and has a plurality of unit cells (3); at least one vibration source (V) which creates vibration on the body (2); unit cells (3) that almost completely absorb the vibration created on the body (2); unit cells (3) located on the plate (4) with an almost completely fixed form.

This invention relates to a vibroacoustic structure system that absorbs acoustic vibration occurring in an air vehicle.

Structural parts of an air vehicle may be exposed to acoustic vibrations due to environmental factors or operation of the motor in the air vehicle. Various vibroacoustic materials are used to reduce and dampen the effects of such vibrations. These materials slow down the transmission of structural vibration. Vibroacoustic structure systems may have a complex structure. These structures can be produced by an additive manufacturing method, thereby enabling production of systems with complex structures. Tensile and bending strengths of these materials should preferably be high. In this way, both light and strong vibroacoustic structures can be obtained.

U.S. Pat. No. 9,514,734B1, which is included in the known-state of the art, discloses a depth-changeable acoustic insulation structure used in an air vehicle. The depth is changed by temperature, so that acoustic waves at different frequencies are dampened.

US20140147656A1, which is included in the known-state of the art, discloses a wave absorber usable in an air vehicle with the capability of dampening frequencies in a variable range through holes of different sizes, and regaining its original shape when deformed.

Thanks to a vibroacoustic structure system according to the present invention, multiple types of vibrations at different frequencies applied to air vehicle are dampened with a single structure.

Another object of the present invention is to provide acoustic vibration damping for an air vehicle by using a lighter and more durable vibroacoustic material.

Another object of the present invention is to provide acoustic vibration damping in a more efficient, practical and cost-effective way.

The vibroacoustic structure system realized to achieve the object of the invention, which is defined in the first claim and other claims dependent thereon, comprises a body on an air vehicle that may be subject to vibration during a movement of the air vehicle; a plurality of unit cells located on the body. There are provided a plate located on the body and consisting of a plurality of unit cells; at least one vibration source that causes vibration on the body; and unit cells almost completely absorbing the vibration caused by the vibration source in the body. Unit cells are located on the plate, with an almost completely fixed structure.

The vibroacoustic structure system according to the invention comprises a plurality of intermediate cells located on the plate between the unit cells and containing a shape memory alloy material; an actuator on the body, which triggers the intermediate cells to change shape and/or form thereof. It comprises the plate having a first position (I) in which at least two unit cells move further away from each other as a result of the actuator triggering the intermediate cells to change shape and/or form, and a second position (II) in which at least two unit cells move closer to each other as a result of the actuator triggering the intermediate cells to change shape and/or form, thereby dampening acoustic vibrations at multiple types of frequencies reaching thereto simultaneously.

In an embodiment of the invention, the vibroacoustic structure system comprises the plate located on the body and consisting of a plurality of regularly structured unit cells and irregularly structured intermediate cells connected to the unit cells, thereby dampening acoustic vibrations at different types of frequencies that reach the body from the vibration source simultaneously.

In an embodiment of the invention, the vibroacoustic structure system comprises the plate in which only the walls of the intermediate cells in contact with each other are made of a shape memory alloy.

In an embodiment of the invention, the vibroacoustic structure system comprises an intermediate wall produced by an additive manufacturing device by mixing the materials of both the unit cell and the intermediate cell in powder form, thereby preventing the deformed intermediate cells from separating from the fixed unit cells, wherein a wall where the intermediate cell wall is in contact with the unit cell wall is provided integrally.

In an embodiment of the invention, the vibroacoustic structure system comprises a sensor which is located on the body and detects a vibration emitted by the vibration source and reaching the body. It comprises a control unit on the body, which is connected to the sensor and actuator and sends information to the actuator upon receiving information from the sensor. It comprises the plate, which is triggered by the actuator to change shape upon a command by the control unit when the vibration is detected by the sensor, in order to dampen the vibration at a frequency predetermined by the manufacturer.

In an embodiment of the invention, the vibroacoustic structure system comprises the plate in which non-moving unit cells are arranged in rows in the same alignment, and intermediate cells are arranged in the same alignment and conjugate along the row.

In an embodiment of the invention, the vibroacoustic structure system comprises the plate in which a unit cell size is greater than an intermediate cell size, thus preventing separations when the intermediate cells are deformed.

In an embodiment of the invention, the vibroacoustic structure system comprises the plate in which the intermediate cells are made of a more flexible material than the material of the unit cells, so that movement of the intermediate cells during deformation prevents separations.

In an embodiment of the invention, the vibroacoustic structure system comprises the control unit which detects the intermediate cell form after a user inputs the form parameter information of the unit cell and performs mathematical operations according to this parameter, thereby triggering the actuator so that the intermediate cells take the detected form.

In an embodiment of the invention, the vibroacoustic structure system comprises the plate that simultaneously dampens vibrations at various frequencies, thanks to the production of intermediate cell walls from different shape memory alloys.

In an embodiment of the invention, the vibroacoustic structure system comprises the plate containing unit cells and intermediate cells in different configurations that are placed consecutively so as to be deformed to adapt vibrations at more than two frequencies, thus damping two different frequencies simultaneously.

In an embodiment of the invention, the vibroacoustic structure system comprises the plate, which is a structural part of an air vehicle.

In an embodiment of the invention, the vibroacoustic structure system comprises the intermediate cell comprising walls with an angular or curved geometry.

The vibroacoustic structure system realized to achieve the object of the invention is illustrated in the attached drawings, in which:

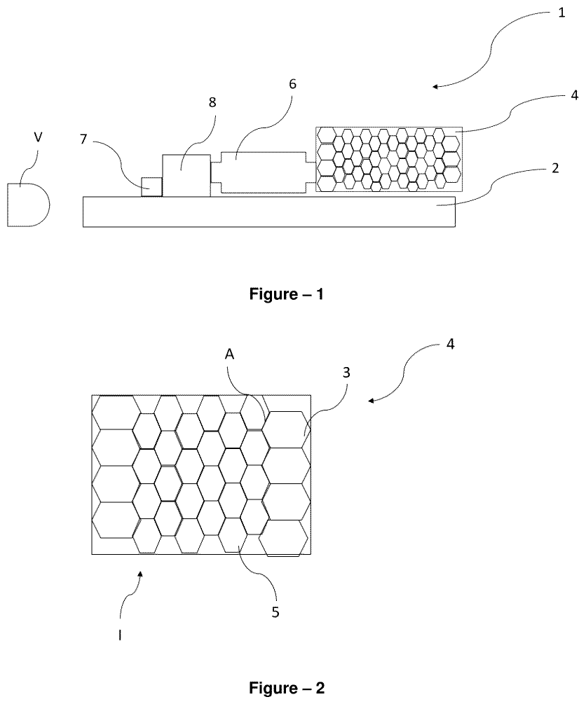

FIG. 1 is a schematic illustration of the vibroacoustic structure system.

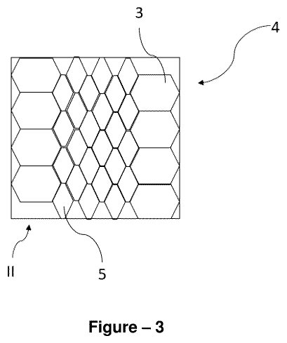

FIG. 2 is a top view of the plate in the first position (I).

FIG. 3 is a top view of the plate in the second position (II).

All the parts illustrated in figures are individually assigned a reference numeral and the corresponding terms of these numbers are listed below:
1. Vibroacoustic Structure System
2. Body
3. Unit Cell
4. Plate
5. Intermediate Cell
6. Actuator
7. Sensor
8. Control Unit
V. Vibration Source
A. Intermediate Wall
I. First Position
II. Second Position

The vibroacoustic structure system (1) comprises a body (2) in an air vehicle, which is subjected to vibration; a plurality of unit cells (3) located on the body (2); a plate (4) located on the body (2), which has a plurality of unit cells (3); at least one vibration source (V) which creates vibration on the body (2); unit cells (3) that almost completely absorb the vibration created on the body (2); unit cells (3) located on the plate (4) with an almost completely fixed form.

The vibroacoustic structure system (1) according to the invention comprises a plurality of intermediate cells (5) located on the plate (4) and between the unit cells (3), containing shape memory alloy material; an actuator (6) located on the body (2), which energizes the intermediate cells (5), thereby enabling the intermediate cells (5) to change shape and/or form; the plate (4) having a first position (I) in which at least two unit cells (3) move away from each other due to the intermediate cells (5) changing shape and/or form when triggered by the actuator (6), a second position (II) in which at least two unit cells (3) approach each other due to the intermediate cells (5) changing shape and/or form when triggered by the actuator (6), thereby allowing that vibrations at multiple types of frequencies reaching thereon simultaneously are absorbed.

The body (2) is subjected to vibration caused by the vibration source (V), such as engine, wing or tail resonance. A plate (4) consisting of unit cells (3) on the body (2) dampens such vibrations reaching the body (2). Unit cells (3) are located on the plate (4) in a fixed position (FIG. 1).

Intermediate cells (5) are located between the unit cells (3). Intermediate cells (5) are located on the plate (4), contain a shape memory alloy and change shape when actuated by the actuator (6) with a trigger such as temperature, electric current or magnetic field. As the intermediate cells (5) are triggered and expanded by the actuator (6), a first position (I) is obtained, in which the unit cells (3) are located far from each other. As the intermediate cells (5) are triggered and narrowed by the actuator (6), a second position (II) is obtained, in which the unit cells (3) are located closer to each other. In this way, the plate (4) can effectively and individually dampen the vibration reaching the body (2) at different frequencies (FIG. 2, FIG. 3).

In an embodiment of the invention, the vibroacoustic structure system (1) comprises the plate (4) located on the body (2), consisting of a plurality of crystalline unit cells (3) and amorphous intermediate cells (5) connected to the unit cells (3), and thus capable of absorbing simultaneous incoming vibrations at different frequencies. Intermediate cells (5) may consist of amorphous structure. The amorphous intermediate cell (5) walls can be deformed effectively. Said intermediate cells (5) and the unit cells (3) having a crystalline structure can be located together in the plate (4). Thus, different acoustic vibrations can be dampened by the plate (4) simultaneously in an effective manner.

In an embodiment of the invention, the vibroacoustic structure system (1) comprises the plate (4) in which only the walls of the intermediate cells (5) that contact with each other are made of a shape memory alloy. Due to the fact that only the walls where the intermediate cells (5) are in contact with each other are made of a shape memory alloy, the intermediate cells (5) triggered by the actuator (6) can be deformed to dampen vibrations at a plurality of frequencies.

In an embodiment of the invention, the vibroacoustic structure system (1) comprises an intermediate wall (A) located in a monolithic manner at the junction of the intermediate cell (5) wall and the unit cell (3) wall, wherein the intermediate wall (A) is produced by an additive manufacturing method by pulverizing and mixing the materials of both the unit cell (3) and the intermediate cell (5) that they are made of, thereby preventing the deformable intermediate cells (5) from separating from the fixed unit cells (3). The walls in contact between the intermediate wall (A), intermediate cell (5) and unit cell (3) are manufactured by an additive manufacturing method with a material that is a mixture of both the material of intermediate cells (5) and the material of the unit cell (3) that they are made of. In this way, the connection between the intermediate cells (5) is prevented from breaking during movement (FIG. 2).

In an embodiment of the invention, the vibroacoustic structure system (1) comprises a sensor (7) located on the body (2) for detecting a vibration to which the body (2) is subjected; a control unit (8) located on the body (2), connected to the sensor (7) and actuator (6), and triggering the actuator (6) with respect to the data received from the sensor (7); the plate (4) triggered by the actuator (6) so as to be deformed upon a command by the control unit (8) when the sensor (7) detects the vibration, in order to absorb the vibration at a frequency predetermined by a user. The sensor (7) located on the body (2) detects the vibration reaching the body (2) from the vibration source (V), and transmits the vibration data to the control unit (8). The control unit (8) processes this data and triggers the plate (4) by alerting the actuator (6) to trigger. Therefore, a structure is obtained, which is capable of dampening the changing frequency when the acoustic vibration frequency changes (FIG. 1).

In an embodiment of the invention, the vibroacoustic structure system (1) comprises the plate (4) on which fixed unit cells (3) are arranged in a row, side by side in the same alignment, and intermediate cells (5) are arranged conjugate and sequentially in the same alignment. Thus, the plate (4) containing cells in a regular structure is obtained.

In an embodiment of the invention, the vibroacoustic structure system (1) comprises the plate (4) in which a size of the unit cell (3) is larger than a size of the intermediate cell (5), thus preventing separations during deformation of the intermediate cell (5). Since the unit cells (3) are larger in size than the intermediate cells (3), their connection with the moving intermediate cells (5) during deformation is ensured, so that they can easily adapt to this deformation.

In an embodiment of the invention, the vibroacoustic structure system (1) comprises the plate (4) in which the intermediate cells (5) are made of more flexible material than the unit cells (3), thus preventing separations during the movement of the intermediate cell (5). Thanks to the intermediate cells (5) made of a more flexible material than the unit cells (3), the connections between the deformed intermediate cells (5) are prevented from breaking during deformation.

In an embodiment of the invention, the vibroacoustic structure system (1) comprises the control unit (8) to which the user inputs form parameter data of the unit cell (3), such that the control unit (8) performs mathematical operations according to this parameter and determine the form of the intermediate cell (5), thereby triggering the actuator (6) in order for the intermediate cells (5) to take the desired form. The user inputs the form data of the unit cell (3) to the control unit (8). The control unit (8) performs operations according to this information, determines the form of the intermediate cell (5) and triggers the actuator (6) so that the intermediate cell (5) takes this determined form. In this way, form of the intermediate cell (5) is determined and vibrations of varying frequencies are dampened.

In an embodiment of the invention, the vibroacoustic structure system (1) comprises the plate (4) that simultaneously absorbs vibrations at different frequencies by means of the walls of the intermediate cells (5) made of different shape memory alloy material. Since it contains different shape memory alloys, the intermediate cells (5) can take on different shapes simultaneously when triggered by the actuator (6), specific to different frequencies.

In an embodiment of the invention, the vibroacoustic structure system (1) comprises the plate (4) containing unit cells (3) and intermediate cells (5) in different configurations that are positioned sequentially so as to be deformed according to more than two frequencies, thus absorbing two different simultaneous frequencies. Thanks to the sequential placement of the plates (4) containing different intermediate cell (5) and unit cell (3) configurations, acoustic vibrations of different frequencies reaching simultaneously can be absorbed in a simultaneous manner.

In an embodiment of the invention, the vibroacoustic structure system (1) comprises the plate (4) forming a structural part of the air vehicle.

In an embodiment of the invention, the vibroacoustic structure system (1) comprises the intermediate cell (5) consisting of walls with angular or curved geometry. Thus, a lightweight plate (4) is obtained.

1. A vibroacoustic structure system (1) comprising a body (2) in an air vehicle, which is subjected to vibration; a plurality of unit cells (3) located on the body (2); a plate (4) located on the body (2), which comprises said plurality of unit cells (3); at least one vibration source (V) which creates vibration on the body (2); said unit cells (3) configured to substantially absorb the vibration created on the body (2); said unit cells (3) located on the plate (4) with an almost completely fixed form, characterized by a plurality of intermediate cells (5) located on the plate (4) and between the unit cells (3), containing shape memory alloy material; an actuator (6) located on the body (2), which energizes the intermediate cells (5), thereby enabling the intermediate cells (5) to change shape and/or form; the plate (4) having a first position (I) in which at least two unit cells (3) move away from each other due to the intermediate cells (5) changing shape and/or form when triggered by the actuator (6), a second position (II) in which at least two unit cells (3) approach each other due to the intermediate cells (5) changing shape and/or form when triggered by the actuator (6), thereby allowing that vibrations at multiple types of frequencies reaching thereon simultaneously are absorbed.

2. A vibroacoustic structure system (1) according to claim 1, characterized by the plate (4) located on the body (2), consisting of a plurality of crystalline unit cells (3) and amorphous intermediate cells (5) connected to the unit cells (3), and thus capable of absorbing simultaneous incoming vibrations at different frequencies.

3. A vibroacoustic structure system (1) according to claim 1, characterized by the plate (4) in which only the walls of the intermediate cells (5) that contact with each other are made of a shape memory alloy.

4. A vibroacoustic structure system (1) according to claim 1, characterized by an intermediate wall (A) located in a monolithic manner at the junction of the intermediate cell (5) wall and the unit cell (3) wall, wherein the intermediate wall (A) is produced by an additive manufacturing method by pulverizing and mixing the materials of both the unit cell (3) and the intermediate cell (5) that they are made of, thereby preventing the deformable intermediate cells (5) from separating from the fixed unit cells (3).

5. A vibroacoustic structure system (1) according to claim 1, characterized by a sensor (7) located on the body (2) for detecting a vibration to which the body (2) is subjected; a control unit (8) located on the body (2), connected to the sensor (7) and actuator (6), and triggering the actuator (6) with respect to the data received from the sensor (7); the plate (4) triggered by the actuator (6) so as to be deformed upon a command by the control unit (8) when the sensor (7) detects the vibration, in order to absorb the vibration at a frequency predetermined by a user.

6. A vibroacoustic structure system (1) according to claim 1, characterized by the plate (4) on which fixed unit cells (3) are arranged in a row, side by side in the same alignment, and intermediate cells (5) are arranged conjugate and sequentially in the same alignment.

7. A vibroacoustic structure system (1) according to claim 1, characterized by the plate (4) in which a size of the unit cell (3) is larger than a size of the intermediate cell (5), thus preventing separations during deformation of the intermediate cell (5).

8. A vibroacoustic structure system (1) according to claim 1, characterized by the plate (4) in which the intermediate cells (5) are made of more flexible material than the unit cells (3), thus preventing separations during the movement of the intermediate cell (5).

9. A vibroacoustic structure system (1) according to claim 5, characterized by the control unit (8) to which the user inputs form parameter data of the unit cell (3), such that the control unit (8) performs mathematical operations according to this parameter and determine the form of the intermediate cell (5), thereby triggering the actuator (6) in order for the intermediate cells (5) to take the desired form.

10. A vibroacoustic structure system (1) according to claim 1, characterized by the plate (4) that simultaneously absorbs vibrations at different frequencies by means of the walls of the intermediate cells (5) made of different shape memory alloy material.

11. A vibroacoustic structure system (1) according to claim 1, characterized by the plate (4) containing unit cells (3) and intermediate cells (5) in different configurations that are positioned sequentially so as to be deformed according to more than two frequencies, thus absorbing two different simultaneous frequencies.

12. A vibroacoustic structure system (1) according to claim 1, characterized by the plate (4) forming a structural part of the air vehicle.

13. A vibroacoustic structure system (1) according to claim 1, characterized by the intermediate cell (5) consisting of walls with angular or curved geometry.
